(19) United States
(12) Patent Application Publication
(10) Pub. No.: US 2026/0237143 A1
(43) Pub. Date: Aug. 13, 2026

(54) MEDICAL IMAGE RENDERING METHOD AND APPARATUS

(71) Applicant: CANON KABUSIKI KAISHA, Tokyo (JP)

(72) Inventors: Magnus WAHRENBERG, Edinburgh (GB); Scott SMITH, Edinburgh (GB)

(73) Assignee: CANON KABUSIKI KAISHA, Tokyo (JP)

(21) Appl. No.: 19/052,503

(22) Filed: Feb. 13, 2025

(51) Int. Cl. G06T 15/08

(52) U.S. Cl. CPC G06T 15/08; G06T 2210/41

(57) ABSTRACT

A medical imaging system and associated method and computer program product for rendering medical images, the system comprising: a renderer configured to receive medical imaging data and render medical images using the medical imaging data, the renderer comprising: a forwards differentiator configured to perform differentiable rendering using forward differentiation to create samples, wherein the samples created by the forwards differentiator are colour and/or intensity samples; and a backwards differentiator configured to perform differentiable rendering using backwards differentiation on samples to generate at least one of: intensity projection, composition and/or rendering integration; wherein the samples from the forwards differentiator and the output of the backwards differentiator are used to form the rendered medical images.

### FIELD

Embodiments described herein relate generally to an apparatus, method and computer program product for medical image data processing, for example processing medical image data in order to render 3D images.

### BACKGROUND

Medical imaging data can be obtained using a range of medical imaging modalities. Rendering 3D models from medical imaging data can present challenges in obtaining a required quality, speed of data processing, the amount of data storage required and data collection. Furthermore, the collected data can in certain circumstances be noisy and effective noise reduction techniques are desirable.

### BRIEF DESCRIPTION OF THE DRAWINGS

Embodiments are now described, by way of non-limiting example, and are illustrated in the following figures, in which:

FIG. 1 is a schematic illustration of an apparatus in accordance with an embodiment;

FIG. 2 is an illustration of a process of rendering images;

FIG. 3 is a flowchart illustrating a process of rendering medical images;

FIG. 4 is an overview of the process of FIG. 3;

FIG. 5 is a flowchart illustrating an example of a process of rendering medical images with an example of a backwards differentiation; and

FIG. 6 is a flowchart illustrating an example of a process of rendering medical images with an alternative example of a backwards differentiation.

### DETAILED DESCRIPTION

Certain embodiments provide a medical imaging system for rendering medical images, the medical imaging system comprising: a renderer configured to receive medical imaging data and render medical images using the medical imaging data. The renderer may comprise a forwards differentiator. The forwards differentiator may be configured to perform differentiable rendering using forward differentiation create samples. The samples created by the forwards differentiator may be colour and/or intensity samples. The renderer may comprise a backwards differentiator configured to perform differentiable rendering using backwards differentiation on samples, e.g. to generate at least one of: intensity projection, composition and/or rendering integration. The samples from the forwards differentiator and the output of the backwards differentiator may be used to form the rendered medical images.

The samples used by the backwards differentiator may be created using the forwards differentiator. The samples used by the backwards differentiator may be recreated by rendering from the original data separately from any samples created by the forwards differentiator. The renderer may be configured to create a 3D volume model representative of the rendered medical images.

The system may comprise at least one optimizer, wherein the at least one optimizer may be configured to optimize one or both of: the output of the backwards differentiator and/or the samples from the forwards differentiator. The output of the optimizer may be used to update a 3D volume model representative of the rendered medical images according to the output of the optimizer. The renderer may be configured to apply a loss function to calculate losses and/or accuracy of the output of the forwards differentiator relative to one or more source images from the medical imaging data. The losses and/or accuracy from the loss function may be used by the optimizer to optimize the 3D volume model representative of the rendered medical images. The forwards differentiator may be configured to perform differentiable rendering using forward differentiation of a rendering function of the 3D volume model to create the samples. The optimizer may be configured to optimize the 3D volume model representative of the rendered medical images based in part on the losses and/or accuracy of the output of the forwards differentiator.

The renderer may be operable to train a neural network representing or outputting some or all the rendering parameters.

Certain embodiments provide a method of rendering medical images, the method comprising receiving medical imaging data; and rendering medical images using the medical imaging data. The rendering may comprise performing differentiable rendering using forward differentiation to create samples. The samples created by the forward differentiation may be colour and/or intensity samples. The rendering may comprise performing differentiable rendering using backward differentiation on samples, which may be to generate at least one of: intensity projection, composition and/or rendering integration. The samples from the forward differentiable rendering and the output of the backwards differentiable rendering may be used to form the rendered medical imaging data. The method may comprise using the above medical imaging system for rendering the medical images.

Certain embodiments provide a non-transient computer readable medium comprising a computer program product, the computer program product being configured such that, when executed by a computer system, causes the computer system to perform a process comprising: receiving medical imaging data; and rendering medical images using the medical imaging data. The rendering may comprise performing differentiable rendering using forward differentiation to create samples. The samples created by the forward differentiation may be colour and/or intensity samples. The rendering may comprise performing differentiable rendering using backward differentiation on samples, for example, to generate at least one of: intensity projection, composition and/or rendering integration. The samples from the forward differentiable rendering and the output of the backwards differentiable rendering may be used to form the rendered medical imaging data.

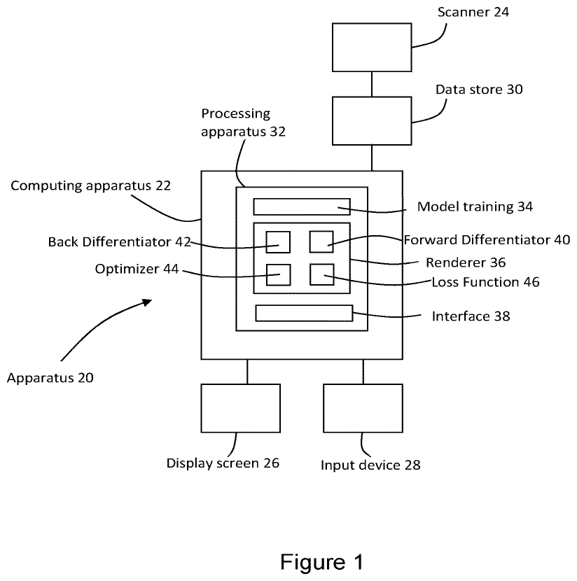

A medical imaging system comprising a data processing apparatus 20 according to an embodiment is illustrated schematically in FIG. 1. In the present embodiment, the data processing apparatus 20 is configured to obtain 2D medical imaging data in one or more acquisition planes. In other embodiments, the data processing apparatus 20 can be configured to process any appropriate data, but in this example processes medical imaging data. The medical imaging data can optionally comprise other associated data, such as context data, data of the data acquisition device used to collect the medical imaging data, amongst others.

The data processing apparatus 20 comprises a computing apparatus 22, which in this case is a personal computer (PC) or workstation. The computing apparatus 22 is connected to a display screen 26 or other display device, and an input device or devices 28, such as a computer keyboard and mouse.

The computing apparatus 22 is configured to obtain image data sets from a data store 30. The image data sets are generated by processing data acquired by a medical imaging scanner 24 and stored in the data store 30. In some examples, the computing apparatus is separate from the medical imaging scanner 24, and configured to process the data obtained from the scanner 24. In other examples, the computing apparatus 22 is integrated with the scanner 24 into a single device or system.

The scanner 24 can be configured to generate the 2D medical imaging data in the one or more acquisition planes in any imaging modality. For example, the scanner 24 may comprise an ultrasound scanner, magnetic resonance (MR or MRI) scanner, CT (computed tomography) scanner, cone-beam CT scanner, X-ray scanner, PET (positron emission tomography) scanner or SPECT (single photon emission computed tomography) scanner or the like. Some specific examples of scanner 24 include a 2D Doppler ultrasound scanner, a phase-contrast MRI scanner, a scanner for performing ultrasound elastography, and a scanner for performing diffusion tensor imaging, amongst others.

In examples, the 2D medical imaging data includes images in the form of average intensity projections (AVIP), such as AVIP SLAB images.

The computing apparatus 22 optionally receives medical image data from one or more further data stores (not shown) instead of or in addition to data store 30. For example, the computing apparatus 22 could receive medical image data from one or more remote data stores (not shown) which may form part of a Picture Archiving and Communication System (PACS) or other information system.

Computing apparatus 22 comprises a processing apparatus 32 for automatically or semi-automatically processing medical image data. The processing apparatus 32 comprises model training circuitry 34 configured to train one or more models; a renderer 36 configured to render the medical image data to obtain one or more 3D fields for example for output to a user or for use in determining one or more clinically relevant properties; and interface circuitry 38 configured to obtain user or other inputs and/or to output results of the data processing.

The renderer 36 comprises functional sub-components that are configured to carry out the rendering, including a forwards differentiator 40, a backwards differentiator 42, an optimizer 44 and a loss function. The forwards differentiator 40 is configured to perform rendering using forwards differentiation to create samples from at least some or all of the medical imaging data. The backwards differentiator 42 is configured to perform rendering using backwards differentiation on samples. The optimizer 44 is configured to optimize at least one of: the output of the backwards differentiator and/or the samples from the forwards differentiator. The loss function 46 is used to calculate losses and/or accuracy of the output of the forwards differentiator relative to one or more source images. The losses and/or accuracy from the loss function is provided as an input to the backwards differentiator, which is configured such that the backwards differentiable rendering on the samples takes into account the losses and/or accuracy determined using the loss function.

Beneficially, the forwards differentiator is configured to generate colour and/or intensity samples from the medical imaging data, whilst the backwards differentiator 42 is configured to perform backwards differentiation on the samples to perform at least one of: intensity projection, composition and/or rendering integration. This specific division of rendering tasks has been found to result in particularly efficient rendering. That is, concepts described herein involve a specific arrangement of mixed mode rendering in which forwards differentiation is used to generate some aspects of the rendering (e.g. colour and/or intensity samples) and backwards differentiation is used to generate different aspects of the rendering (at least one of: intensity projection, composition and/or rendering integration) to those aspects generated by the forwards differentiation. These are then combined in order to form the final rendering. This specific arrangement results in those aspects of the rendering being performed in the way (e.g. forwards or backwards rendering) that results in the most efficient implementation on computer based processing systems.

In the present embodiment, the circuitries 34, 36, 38 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays). The computing apparatus 22 also includes a hard drive and other components of a PC including RAM, ROM, a data bus, an operating system including various device drivers, and hardware devices including a graphics card. Such components are not shown in FIG. 1 for clarity.

The data processing apparatus 20 of FIG. 1 is configured to perform methods as illustrated and/or described in the following.

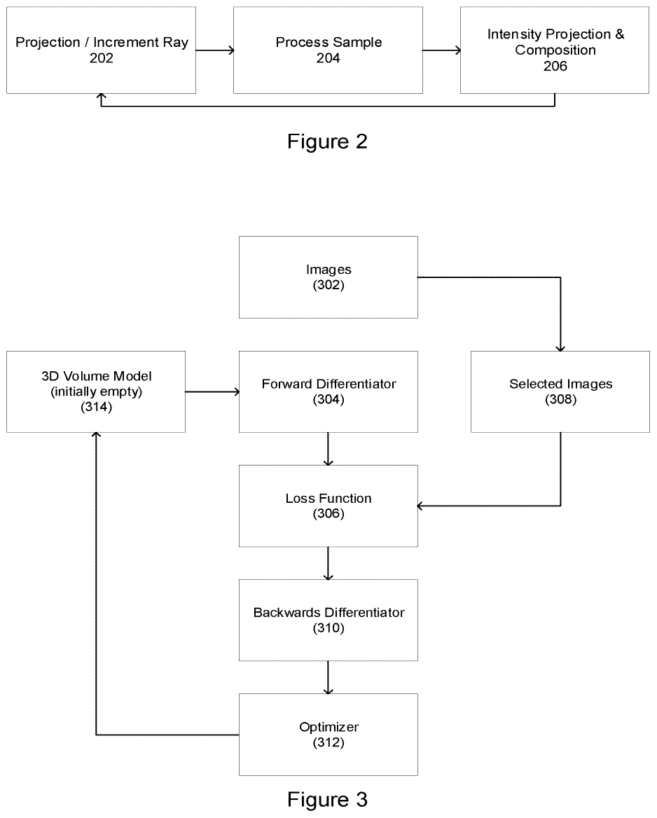

An overview of the rendering process is illustrated in FIG. 2. In step 202, ray tracing is performed wherein pixels are associated with rays traced from a scene in order to create a sample. At step 204, sample processing is performed in order to determine parameters such as the colour and intensity of the sample. At step 206, intensity projection is performed to determine intensity along the rays, wherein the intensity of the light from the rays through that pixel is integrated over the pixel and composited. The process then cycles back to step 202, which increments to the next ray in the ray tracing process.

The rendering processes described herein are neural rendering processes, in which AI techniques such as neural networks are used to aid the rendering process. In examples, the rendering processes are used to derive 3D models and associated images from 2D input medical images. Specifically, the neural rendering processes described herein utilise differentiable rendering. Differentiable rendering involves determining the derivatives of a rendering function with regard to various parameters using automatic differentiation. An image rendered from a 3D model is generally the product of complex coupling involving reflections, shadows and inter-reflections and as such finding the inverse of a rendering function (i.e. moving from a rendered image back to the original model) can be challenging. By having a differentiable rendering function, the rendering can be approached as a typical descent/minimisation problem.

A rendering algorithm can be represented as a function g(x), which transforms a scene descriptor (x), that comprises a plurality of parameters that describe the scene, into a rendering (y) of the scene. In other words, the rendering y is obtained by applying the function g(x) to the scene description x such that y=g(x). The differential of the function g(x) with respect to x, i.e.

$$( \frac{dy}{dx} )$$

or g′(x), is representative of how the rendering y of the scene changes with variations in the parameters of the scene descriptor x. A function f(y) can be used as an objective function h(x), that is h(x)=f(g(x)). The derivative of h(x) with respect to x, i.e.

$$( \frac{d h ( x )}{d x} ) = {h}^{′} ( x ) = {f}^{′} ( {g}^{′} ( x ) ) {g}^{′} ( x ) ,$$

can be used to arrive back at the parameters of the scene descriptor x. A suitable optimisation algorithm, particularly a stochastic descent algorithm or an extension of a stochastic descent algorithm such as Adam, an adaptive gradient algorithm, root mean square propagation, or the like, can be used to optimise the parameters of the scene descriptor x.

By application of the chain rule, a nested derivative can be converted into a product of individual derivatives. So, for example, for h(x)=f(g(x)), the derivative of the function h′(x)=f′(g(x))g′(x). Operations will have their own rules. For example, multiplication is defined by the product rule, for addition it's the sum rule etc.

This product can be evaluated in two different ways. In forwards differentiation, the product is evaluated from the independent variable first (i.e. from g′(x)) and works up, whilst in backwards differentiation (also called adjoint differentiation), the product is evaluated from the result first, i.e. it starts with f′ and then works its way down the hierarchy.

Rendering using forwards differentiation and rendering using backwards differentiation each have their own characteristics. For example, rendering using forwards differentiation can be implemented as custom numerical types, no graph is needed and repeat calculation is needed for each independent variable. Rendering using backwards differentiation typically requires a previously determined computation graph, and requires batching or parallel operations but involves less repeated operations and can be implemented using polymorphism or just-in-time (JIT) compilation. As such, forwards differentiation is chosen for some renderings or backwards differentiation can be chosen for other renderings, depending on the specifics of the particular rendering.

In particular, forward differentiation is generally preferred and can be implemented with a relatively simple system that does not require a compute graph or JIT processing. However, this approach is most computationally efficient with current processors with lower numbers of variable, e.g. <100 independent variables. In contrast, backward differentiation can be more computationally efficient for especially large parameter sets, such as those containing 106 or more independent variables. However, again there are trade-offs, such as for storage/memory requirements, with this approach typically requiring more memory usage than forward differentiation and can be more complex in terms of GPU usage and implementation. As such, determining the best approach to use is not trivial.

However, the present inventors identified that certain sub-processes within a rendering are more suited to solution by forwards differentiation and other processes within the same rendering operation are more suited backwards rendering.

The present inventors identified that most of the complexity in volume rendering is in the sample processing (204 in FIG. 2). As such, rendering using forwards differentiation for processing the samples is fast and highly computationally efficient for this part of the rendering. However, the present inventors have also identified that the number of independent parameters significantly increases for the intensity projection and composition step (206 in FIG. 2). As such, the present inventors have identified that rendering using backwards differentiation significantly out-performs forwards differentiation for these actions, in terms of speed, and computational resource utilisation. As such, described herein is a specific hybrid differentiable rendering process that uses a specific application of forwards differentiation and backwards differentiation. Specifically, forwards differentiation is used for the sample processing 204 and backwards differentiation is used for the intensity projection and composition 206.

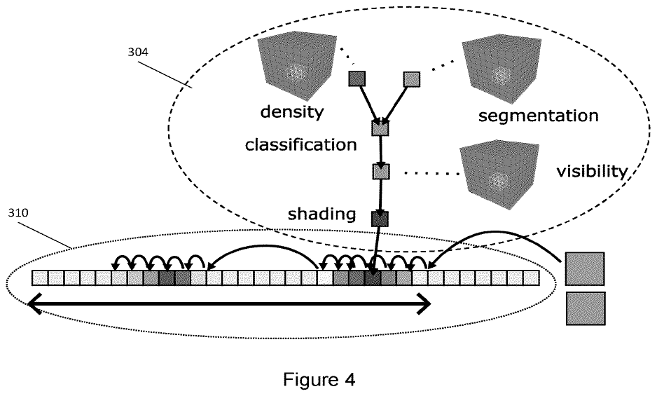

The process is illustrated in FIGS. 3 and 4. FIG. 3 is a flowchart illustrating a method of rendering medical images. FIG. 4 illustrates the types of differentiable rendering used for different sub-processes of the rendering method shown in FIG. 3. Optionally but not essentially, the process can be implemented using the apparatus 20 shown in FIG. 1, particularly by the renderer 36 thereof.

In 302, images from a medical imaging system are received. Examples of medical images are discussed above in relation to FIG. 1. In this example, these are received in the form of 2D medical imaging data that includes images in the form of average intensity projections (AVIP), such as AVIP SLAB images. The method aims to construct a 3D volume model 214 from the images received at 302, and create rendered 2D images therefrom. Initially, the volume model 314 is empty (or is a default, random, selected or pre-selected starting model or noise). The model comprises various parameters that define the model, as is known in the art.

In 304, the forward differentiator 40 is operable to perform forward differentiable rendering using forward differentiation in order to create samples of an image representative of the 3D model. The forward differentiator can take as inputs the parameters (scene parameters) of the model 314 (which could be an empty, default, random, selected or pre-selected model for the initial pass), optionally along with other rendering parameters, such as materials, lights, camera position/angle, etc. Specifically, the forward differentiator is configured to generate sample colour and intensity values corresponding to each pixel of the image by forwards differentiation of a differentiable rendering function applied to the model. The forwards differentiation can take advantage of the chain rule to use forwards differentiation in which the product is evaluated from the independent variable first (i.e. from g′(x)) to generate the sample colour and intensity values corresponding to each pixel of the image. Examples of other approaches include those applied to operations such as the sum rule for addition/subtraction, i.e.: if f(x)=u(x)+v(x), then; f′(x)=u′(x)+v′(x) and the product rule for multiplication, i.e.: if f(x)=u(x) xv(x), then: f′(x)=u′(x)×v(x)+u(x)×v′(x).

In 306, a loss function for the images (e.g. colour and/or intensity values of images) generated by the forward differentiator 40 is calculated, wherein the loss function represents the losses of the images generated by the forward differentiator 40 relative to selected images 308 from the set of images received in 302, which may be pre-defined source images selected from the set of images received in 302. Any suitable loss function could be used. In some examples, the loss function is applied to generate loss maps that map losses or differences between the samples (e.g. colour and intensity values) created by the forward differentiator 40 and the pre-defined source images.

The losses (e.g. the loss map) determined using the loss function in step 306 are passed to the backwards differentiator 42 at 310. Optionally, but not essentially, the backwards differentiator also receives the samples created by the forwards differentiator 40 using forward differentiable rendering as an input, as will be discussed below. The backwards differentiator 42 is configured to perform rendering using backwards differentiation (also called adjoint differentiation) of a differentiable rendering function in step 310 to determine the pixel integral for each pixel by combining samples using composition or intensity projection. The intensity projections may comprise average or maximum intensities along projected rays through voxels and projected onto a visualisation plane. In examples, the backwards differentiator 42 is configured to utilise at least one or all of: intensity projection (e.g. maximum, minimum or average intensity projection), alpha composition such as the over/under operator, and/or finally attenuation in which an initial value or colour is attenuated by repeatedly multiplying the value with a transmission percentage. The effect of the backwards differential rendering is to output a parameter gradient, the parameters being parameters of the 3D model.

In examples, the forward differentiation is arranged to create d samples/d parameters (including individual voxels). The backward differentiation is arranged to create d final image outputs/d samples. These outputs of the forwards and backwards differentiations are then combined to create the full chain d final output/d parameter (including individual voxels).

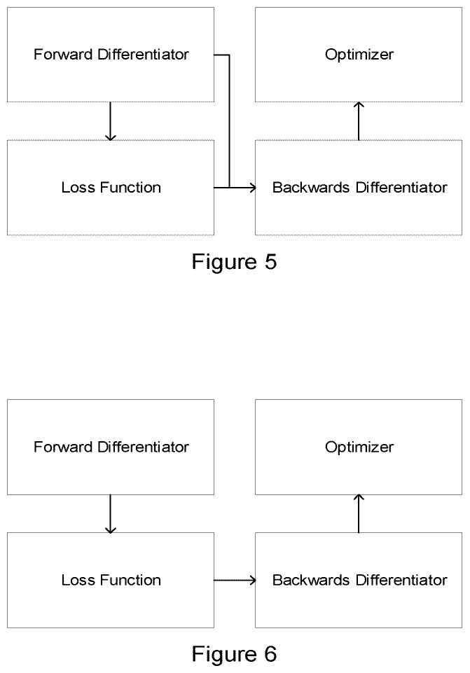

Two different possible approaches to the rendering using backwards differentiation 310 performed by the backwards renderer 42 are illustrated in FIGS. 5 and 6.

FIG. 5 illustrates an approach in which the samples (e.g. an intensity and/or colour array) and optionally also the computation graph of gradient values from the differentiable rendering using forward differentiation (i.e. from the forward differentiator 40, as calculated in step 304 of FIG. 3) are provided as inputs to the backwards differentiator 42 and used as inputs to the differentiable rendering using backwards differentiation in step 310, along with the losses (i.e. the loss image) from the loss function step 306. This approach is more straightforward, but could have relatively large storage/memory requirements.

A different approach is illustrated in FIG. 6. In this approach, neither the samples nor any computation graph from the forwards differentiator 40 are supplied to the backwards differentiator 42. Instead, the renderer 36 (e.g. the backwards differentiator 42) is configured to generate samples for the purpose (e.g. exclusive purpose) of performing the differentiable rendering using backwards differentiation 310. The present inventors have identified that rendering up new samples specifically for the backwards differentiation step can take a broadly equivalent amount of time and/or computational resource as reading a very large array of intensity/gradient values (as would be the case if the backwards differentiator 42 had to read the stored output of the forwards differentiator 40). However, by rendering new samples as part of, and specifically for, the differentiable rendering using backwards differentiation 310, the inputs to the backwards differentiator 42 are simplified and the memory storage requirements can be significantly reduced relative to the approach outlined in FIG. 5.

In 312, the output from the backwards differentiator 42 (i.e. from the differentiable rendering using backwards differentiation performed in step 310) is passed to an optimizer, which is configured to optimize the parameters based on the output of the loss function (i.e. the loss map) and the outputs of the forwards and backwards differentiators 40, 42. In examples, the optimizer is configured to implement a stochastic descent algorithm or an extension of a stochastic descent algorithm such as Adam, an adaptive gradient algorithm, root mean square propagation, or the like.

In 314, the optimized parameters from the optimizer from step 312 are used to update the 3D volume model according to the optimized parameters.

As can seen from FIG. 3, the process iteratively repeats around steps 304, 306, 310, 312 and 314, each time improving the parameters, until a set or pre-set completion condition is met (e.g. losses determined form the loss function 306 being below a threshold or a quality of fit being above a threshold, or until a reduction in losses or increase in quality of fit from iteration to iteration is below a certain level, etc.). At which point, the model 314 and the rendered images formed from the colour and intensity values from the forward differentiator 40 and the intensity projections from the backwards differentiator 42 are finalised.

One way of looking at the process above is that forward differentiation is used to create d sample(s)/d parameter(s), which could include individual voxels. Backward differentiation is used to create d final image output/d samples. These outputs from the forward differentiation and the backwards differentiation are combined to create the full chain d final output/d parameter, including individual voxels.

FIG. 4 illustrates the division of the rendering process between the differentiable rendering using forward differentiation 304 (to produce samples such as colour and intensity values) and the differentiable rendering using the backwards differentiation 310 to generate the intensity projection. That is, the present invention is not simply a hybrid renderer 36 that employs forwards and backwards differentiation 304, 310, but rather specific types of sub-processes within the overall rendering process are divided in a specific manner to achieve a renderer that efficiently uses computing resources and/or increases the rendering speed when performed on current processing systems.

Specifically, as shown in FIG. 4, parameters such as density, segmentation, classification, shading and visibility for each volume element of the model are used as part of the differentiable process using forwards differentiation of the rendering function in order to create sample colour and intensity values. Backwards differentiation of the rendering function is used to determine the pixel integral by combing samples using composition or intensity projection. As noted above, the rendering using the backwards differentiation uses a fixed function that relies on specifically re-rendered samples rather than a computation graph derived from the rendering process that uses forward differentiation.

The processes described above can be used to generate 3D models using 2D medical images by using differentiable rendering that uses both forward differentiation of a rendering function to generate at least colour and/or intensity values of images, and backwards differentiation of a rendering function to generate intensity projections, along with a loss function that compares the generated images to reference images from the 2D medical images and an optimizer, that optimizes the parameters of the model based on the output of the loss function in an iterative process to indirectly generate the 3D model and associated 2D rendered images based on the model. The 3D model is not directly generated from the 2D medical images, but rather the 2D medical images are used as the “ground truth” input in the optimisation to guide a starting model (e.g. a blank model, a pre-set model, a default model etc.) towards a 3D model that gives rise to rendered 2D images that meet a quality of fit condition to the 2D medical images. Forwards differentiation of a rendering function is specifically used for colour and/or intensity value generation, and backward differentiation of a rendering function is specifically used for intensity projection to arrive at a faster renderer and/or a render that more efficiently makes use of memory and/or processor resource compared to otherwise similar renders that purely use forwards or backwards differentiation.

Although specific examples are described above, the present disclosure is not limited to the specific examples, and variations to the specific examples given above are possible.

For example, although Adam is given as a beneficial example of an optimizer, other optimizers could be used, such as a suitable stochastic descent algorithm or other extension of a stochastic descent algorithm such as an adaptive gradient algorithm, root mean square propagation, or the like.

In addition, although specific examples of medical images are given, the medical images could comprise images produced by any suitable medical imaging device such as an ultrasound scanner, magnetic resonance (MR or MRI) scanner, CT (computed tomography) scanner, cone-beam CT scanner, X-ray scanner, PET (positron emission tomography) scanner or SPECT (single photon emission computed tomography) scanner or the like. Some specific examples include a 2D Doppler ultrasound scanner, a phase-contrast MRI scanner, a scanner for performing ultrasound elastography, and a scanner for performing diffusion tensor imaging, amongst others.

In general, a key use case involves optimizing volumetric data from correlated image data, such as medical image data collected by medical imaging apparatus. This could comprise simply reforming the data or data visibility masks from an existing render. Another use case is to have the rendering mimicking a physical process such a virtual x-ray (digital reconstructed radiograph). In this case, multiple images from a medical imaging apparatus, such as x-ray images from an x-ray device, which could be a regular x-ray, C-arm x-ray, intervention suite C-arm x-ray or the like, are used to reconstruct a 3D representation of a body or part of a body being imaged. This would be somewhat analogous to the use of NERF (Neural Radiance Fields) in photogrammetry. In this, differentiable ray tracing techniques are used to reconstruct real world 3D data from photos. The ray tracing mimics the real world light transport and camera action. In addition to the above, the differentiable render as described herein can be a layer in training a neural network model, where the loss and the regression happens on rendered images, but the network itself is tasked with creating volume data of some kind.

In specific examples, the techniques presented herein can be used to form 3D models from medical imaging data, wherein those 3D models could then be used in the rendering of images according to different viewpoints, lighting or with different image parameters to the original medical images. That is, the processes described herein, in specific examples, can be used to provide rendered medical images from the 3D model produced using the input medical images, wherein the rendered medical images can be of any required viewpoint, lighting, or other image parameter, e.g. as selected by medical practitioner, radiologist or other user. It this way, a much improved medical imaging device can be obtained, that is capable of providing imaging options beyond the collected medical images. However, this is only an exemplary application, and other applications are envisaged.

The features described herein may be implemented in software, firmware, hardware, or a combination thereof. In the case of a software implementation, features could be embodied in program code that performs specified tasks when executed on a processor (e.g. CPU or CPUs). The program code can be stored in one or more computer readable memory devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

References to a processor is made herein and any of the methods described herein could be implemented at least in part on a processor. However, the use of processor herein should not be construed narrowly and could include a multi-core processor. Furthermore, the processor could be or include but are not limited to at least one of: one or more digital signal processors (DSPs), one or more field programmable gate arrays (FPGAs), one or more integrated FPGA/processor systems, one or more application specific integrated circuits (ASICS), an adaptive compute acceleration platform (ACAP), one or more system on chip (SoC) devices, one or more maths co-processors, one or more AI accelerators such as a tensor processing unit (TPU), one or more graphics processing units (GPUs) and/or the like.

At least part of the processes described herein could be implemented using software that is processed by suitable hardware to perform at least part of the process. This could be implemented by a computer. The term “computer” as used herein could be any electronic processing device or system, for example as described herein.

As such, the specific examples are provided herein to aid the understanding of the reader and the scope of the present disclosure is not limited by the specific examples described herein.

1. A medical imaging system for rendering medical images comprising:
a renderer configured to receive medical imaging data and render medical images using the medical imaging data, the renderer comprising:
a forwards differentiator configured to perform differentiable rendering using forward differentiation to create samples, wherein the samples created by the forwards differentiator are colour and/or intensity samples; and
a backwards differentiator configured to perform differentiable rendering using backwards differentiation on samples to generate at least one of: intensity projection, composition and/or rendering integration;
wherein the samples from the forwards differentiator and the output of the backwards differentiator are used to form the rendered medical images.

2. The system of claim 1, wherein the samples used by the backwards differentiator are created using the forwards differentiator.

3. The system of claim 1, wherein the samples used by the backwards differentiator are recreated by rendering from the original data separately from any samples created by the forwards differentiator.

4. The system of claim 1 wherein the renderer is configured to create a 3D volume model representative of the rendered medical images.

5. The system of claim 1, further comprising at least one optimizer, wherein the at least one optimizer is configured to optimize one or both of: the output of the backwards differentiator and/or the samples from the forwards differentiator.

6. The system of claim 5, wherein the output of the optimizer is used to update a 3D volume model representative of the rendered medical images according to the output of the optimizer.

7. The system of claim 6, wherein the renderer is configured to apply a loss function to calculate losses and/or accuracy of the output of the forwards differentiator relative to one or more source images from the medical imaging data, and the losses and/or accuracy from the loss function is used by the optimizer to optimize the 3D volume model representative of the rendered medical images.

8. The system of claim 6, wherein the forwards differentiator is configured to perform differentiable rendering using forward differentiation of a rendering function of the 3D volume model to create the samples.

9. The system of any of claim 7, wherein the optimizer optimizes the 3D volume model representative of the rendered medical images based in part on the losses and/or accuracy of the output of the forwards differentiator.

10. The system of claim 1, wherein the renderer is operable to train a neural network representing or outputting some or all the rendering parameters.

11. A method of rendering medical images, the method comprising:
receiving medical imaging data; and
rendering medical images using the medical imaging data, wherein the rendering comprises:
performing differentiable rendering using forward differentiation to create samples, wherein the samples created by the forward differentiation are colour and/or intensity samples; and
performing differentiable rendering using backward differentiation on samples to generate at least one of: intensity projection, composition and/or rendering integration;
wherein the samples from the forward differentiable rendering and the output of the backwards differentiable rendering are used to form the rendered medical imaging data.

12. A non-transient computer readable medium comprising a computer program product, the computer program product being configured such that, when executed by a computer system, causes the computer system to perform a process comprising:
receiving medical imaging data; and
rendering medical images using the medical imaging data, wherein the rendering comprises:
performing differentiable rendering using forward differentiation to create samples, wherein the samples created by the forward differentiation are colour and/or intensity samples; and
performing differentiable rendering using backward differentiation on samples to generate at least one of: intensity projection, composition and/or rendering integration;
wherein the samples from the forward differentiable rendering and the output of the backwards differentiable rendering are used to form the rendered medical imaging data.
